(19) United States
(12) Patent Application Publication
(10) Pub. No.: US 2005/0259412 A1
(43) Pub. Date: Nov. 24, 2005

(54) Portable electric light

(76) Inventor: Junji Hiromori, Tokyo (JP)

Correspondence Address: DILWORTH & BARRESE, LLP, 333 EARLE OVINGTON BLVD., UNIONDALE, NY, 11553, US

(21) Appl. No.: 10/849,431

(22) Filed: May 19, 2004

(51) Int. Cl. B25F 3/00

(52) U.S. Cl. 362/157

(57) ABSTRACT

The present invention is directed to a portable electric light such as a flashlight having a main stem or shaft for containing at least one battery or dry cell for operating an electric light bulb mounted upon one end of the stem or shaft, and a cover removably secured to the main stem or shaft cover and protect the electric light bulb. A separate outer concentric member at least partially formed of transparent material is removably inserted about the main stem or shaft such that labeling, indicia or images upon an outer surface of the main stem or shaft are clearly visible through the outer concentric member.

### BACKGROUND OF THE INVENTION

The present invention is directed to an improved portable electric light such as a flashlight. More specifically, the present invention is directed to an improved portable electric light in which indicia such as designs, patterns, labeling, etc. can easily be affixed upon an outer surface of a main stem or shaft of the portable electric light containing at least one battery and protected from damage during use.

Portable electric lights such as flashlights which operated upon dry cells or batteries are well-known and generally comprise a main stem or shaft for containing the dry cell or battery and an electric light bulb mounted upon one end of the main stem or shaft. A cover is generally provided to protect the electric light bulb from damage and magnify transmission of light from the bulb, e.g., by situating reflective surface about an inner curved surface of the cover that surrounds the electric light bulb upon assembly.

There has been a need to properly label such portable electric lights, e.g., with safety information, instructions for assembly or use, or even decorative features and advertising. Such portable electric lights had not always been so successfully labeled, i.e., prior to shipping, resulting in damage to the labeling during transit. Concomitantly, it has not always been feasible to properly label such portable electric lights upon arrival at destination. Moreover, it is often necessary to re-label such portable electric lights upon arrival at destination. For example, the portable electric light could have been labeled in one language prior to shipment but then needs to be re-labeled if ultimately shipped into a country having a different foreign language. Moreover, such labeling still needs to be protected from damage during use. It might even become necessary to change such labeling after use for a period of time.

### SUMMARY OF THE INVENTION

Accordingly, it is an object of the present invention to improve manufacture and operation of a portable electric light such as a flashlight.

It is a more specific object of the present invention to improve display of images and/or information upon the portable electric light itself.

It is also an object of the present invention to improve safety in transporting, assembling and operating a portable electric light.

These and other objects are attained by the present invention which is directed to a portable electric light such as a flashlight having a main body or shaft arranged for an electric light bulb to be detachably mounted upon one end thereof and to contain at least one battery or cell for supplying power to the electric light bulb, a cover arranged to be detachably secured to the main body or shaft to cover the light bulb, and an outer body at least partially formed of substantially transparent material and arranged to concentrically encompass the main body or shaft to allow images printed or affixed upon an outer surface of the main body or shaft to be visible through the outer concentric body.

More specifically, the outer concentric body is removably mounted upon the main stem or shaft to allow removal therefrom and replacement, e.g., of the images or patterns mounted upon the outer surface of the main stem or shaft. These images or patterns can include lettering, e.g. advertising or even operating and safety information. In one preferred embodiment, the main stem or shaft comprises a concentric projection, with the outer transparent body arranged to mate with this concentric projection to couple the components together. The projection and outer transparent body can be complementary threaded to screw together upon assembly.

In an alternative embodiment, the cover and outer transparent body are arranged to be coupled together about the main stem or shaft to secure the shaft or stem within the outer transparent body, e.g., by providing requisite portions of the cover and transparent body with complementary threads allowing the cover and transparent body to be screwed together. Any of a variety of switching mechanisms can be provided for turning the electric light bulb on or off, e.g., a sliding or push-button switch mounted upon the main stem or shaft, or switching mechanism actuated by rotating the cover about the main stem or shaft.

The components themselves may take any convenient geometric shape. For example the main stem or shaft and/or the outer transparent body can each be substantially cylindrical or alternatively, possess any acceptable polygonal shape, e.g., a substantially triangular, rectangular, square or hexagonal cross-section. Furthermore, the components can be formed of any acceptable material, e.g., metallic and/or synthetic material such as plastic. In this regard, the outer transparent body can be made entirely transparent and/or formed of transparent material such as glass, acrylics, polycarbonates, etc.

### BRIEF DESCRIPTION OF THE DRAWINGS

The present invention will be described in greater detail with reference to the accompanying drawings in which:

FIG. 1 illustrates an exploded perspective view of an embodiment of the portable light in accordance with the present invention;

FIG. 2 illustrates a perspective view of the assembled light shown in FIG. 1;

FIG. 3 illustrates an exploded perspective view of an alternative embodiment of the portable light in accordance with the present invention;

FIG. 4. illustrates a perspective view of the assembled light shown in FIG. 3;

FIG. 5 illustrates an exploded perspective view of another embodiment of the portable light in accordance with the present invention;

FIG. 6 illustrates a perspective view of the assembled light shown in FIG. 5;

FIG. 7 illustrates an exploded perspective view of a further embodiment of the portable light in accordance with the present invention; and

FIG. 8 illustrates a perspective view of the assembled light shown in FIG. 7.

### DESCRIPTION OF THE PREFERRED EMBODIMENTS

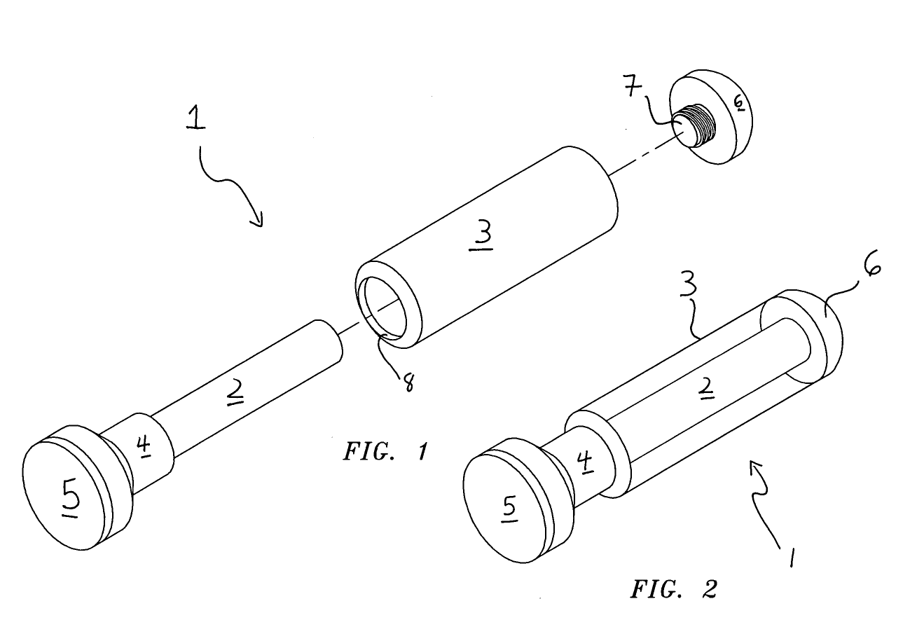

Referring to the drawings, FIGS. 1 and 2 illustrate one embodiment of the portable electric light 1 according to the present application, in which an electric light bulb (not shown) can be screwed into a main body or shaft 2 which contains a cell such as a dry cell or battery (not shown) for supplying power to the light bulb. A cover 5 is freely detachably mounted upon the shaft 2 to cover the light bulb, e.g., to slidably fit into or onto an outer circumferential surface of a front end of the main shaft 2 to cover and protect the light bulb screwed onto the front end of the shaft 2. Additionally, an outer cylindrically-shaped member 3 formed of transparent material is arranged to be inserted over and encompass the main shaft 2 of the light 1 in assembled condition.

More specifically, the main shaft 2 is provided with an annular projection 4 arranged such that a front end 8 of the cylindrically-shaped outer transparent member 3 can fit into this annular projection during assembling as shown and securely encompass the main shaft 2 which is retained therein. In the embodiment shown in FIGS. 1 and 2, the projection 4 comprises a partially cut-away portion (not shown) in a radial direction with the outer transparent body 3 having a convex front end 8 as shown structured and arranged to be inserted into the cut-away portion of the annular projection 4 and then rotated to secure the outer body 3 to the main body or shaft 2. Thus, the main shaft 2 is visible through the outer transparent cylindrical member as shown in FIG. 2, after assembly. Accordingly, images such as lettering, labeling, designs, patterns, advertising, etc. affixed to an outer surface of the main stem 2 are clearly, reliably viewed through the outer transparent member 3.

These images can be directly imprinted upon the main shaft itself or applied thereto, e.g., by decals. For example, it is now possible to affix directions for operating the portable electric light directly to the main shaft 2 where the instructions will always be visible for viewing, even after assembling. This improves operating the portable electric light and will inform one who is unfamiliar with the electric light how to operate the same, even after assembling of the electric light.

In the embodiment illustrated in FIGS. 1 and 2, there is an annular space provided between the inner shaft 2 (which has smaller diameter) and outer transparent member 3 upon assembling, as shown. This allows, even three-dimensional images to be inserted between the shaft 2 and outer cylindrical member 3 upon assembling (such three-dimensional images would be secured upon the main stem 2 in FIG. 1 prior to assembling as shown). However, the outer surface of the shaft 2 and inner surface of transparent body 3 can be arranged to be substantially flush with one another, within the context of the present invention.

For example, the images positioned upon the main stem 2 can be comparatively small, and the outer transparent body 3 formed from material magnifying the images upon the main stem 2. This would allow, e.g., fairly small, fine, printing to be affixed to the main stem 2 surface and then conveniently magnified by the material forming the outer transparent body 3 to enhance viewing therethrough. Additionally, the length of the substantially cylindrically-shaped outer transparent body 3 approximates the length of the inner main stem or shaft 2 between the annular projection 4 and opposite rear end thereof.

In the embodiment shown in FIGS. 1 and 2, a cap 6 is provided with a threaded projection 7 designed to be screwed into a corresponding female threaded portion (not shown) within the main stem 2 from an end opposite the annular projection 4 and cover 5, to thereby secure the outer transparent member 3 between the annular projection 4 and cap 6 as shown in assembled condition in FIG. 2. The main stem 2 and cap 6 are brought together in the direction of the dash-dot line shown in FIG. 1. When a battery held within the main shaft 2 must be replaced, the rearwardly-mounted cap 6 need only be unscrewed to allow replacement. However, other means of securing the electric light components together are also contemplated within the purview of the present invention.

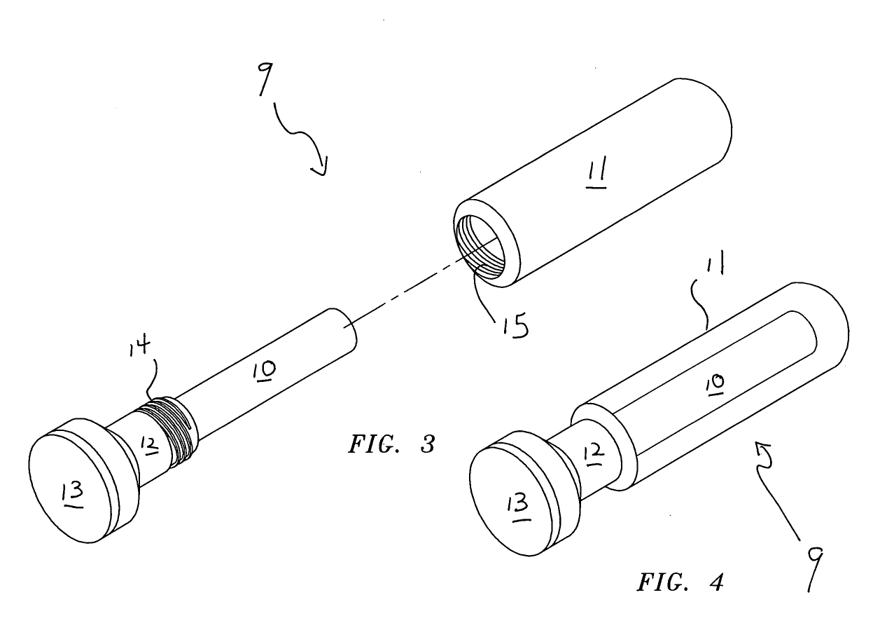

FIGS. 3 and 4 illustrate an alternative embodiment of a portable electric light 9 in accordance with the present invention, in which an outer surface 14 of the annular projection 12 upon the main shaft 10 is provided with threads and an inner surface of the front end 15 of the transparent body 11 with complementary threads, such that the main shaft 2 and outer transparent body 11 can be screwed and secured together to form an assembled electric light 9 as shown in FIG. 3. The main stem 10 and outer transparent body 11 are brought together in the direction indicated by the dash-dot lines in FIG. 3.

In this embodiment, need for a separate cap 6 to secure the various components together, is eliminated, with the rear end of the outer transparent body 11 opposite the threaded front end 15 remaining closed. Thus, the total number of separate components forming the assembled electric light 9 is reduced. However, in the embodiment shown in FIGS. 3 and 4, the outer transparent member 11 and inner shaft 10 must now be totally unscrewed from one another to remove and replace batteries held within the inner shaft 10. The cover 13 is mounted upon the main shaft 10 in similar fashion to mounting of cover 5 upon shaft 2 in the embodiments shown in FIGS. 1 and 2.

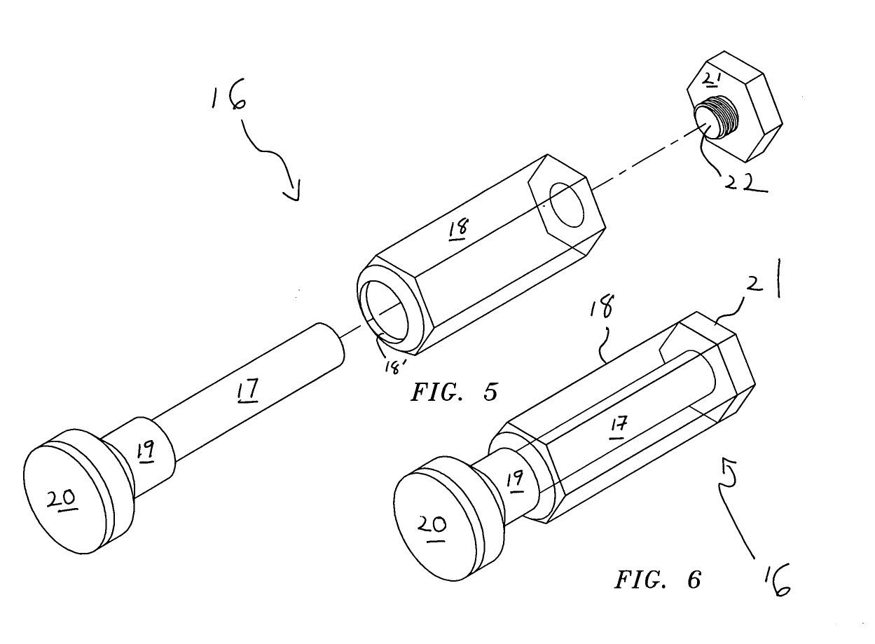

FIGS. 5 and 6 illustrate an embodiment of a portable electric light 16 similar to the embodiment shown in FIGS. 1 and 2, but where the outer transparent member 18 is polygonally-shaped, i.e., possesses a multi-faceted or polygonal cross-section as shown. In other respects, assembling and operating of the inventive electric light 16 is similar to the embodiment shown in FIGS. 1 and 2, with the cover 20 secured to main stem 17 in similar fashion, and main stem 17 provided with an outer annular projection 19 designed to mate with a front end 18′ of outer transparent body 18 as shown. All components are brought together in the direction of the dash-dot lines in FIG. 5, with the threaded projection 21 upon rear end cap 22 screwed into complementary threads within the rear end of the main shaft 17 (not shown). The outer transparent body 18 is illustrated with hexagonal cross-section in FIGS. 5 and 6 but may also take a variety of polygonal shapes, e.g., possess triangular, rectangular and square cross-sections (for example, the outer body 18 itself can be substantially in the shape of a rectangular parallelepiped).

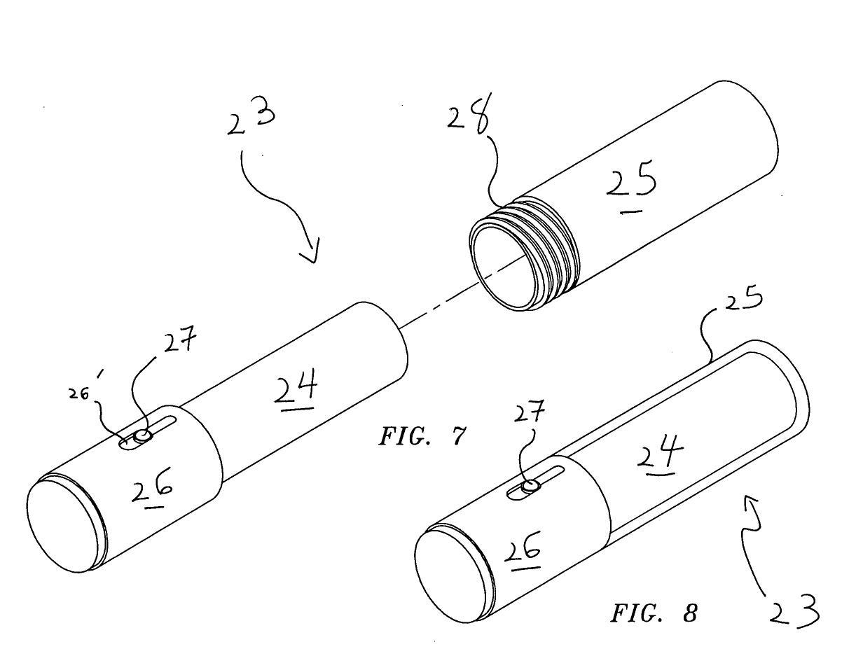

The embodiment illustrated in FIGS. 7 and 8 is directed to an alternative embodiment of the portable electric light 23 in accordance with the present invention, in which the outer, cylindrically-shaped transparent body 25 is secured to the cover 26 to encompass the inner main stem 24. More particularly, the main body or shaft 24 is also arranged to have an electric light bulb (not shown) mounted upon one end thereof and contain at least one battery for supplying power to the electric light bulb. The cover 26, which is substantially cylindrically shaped, is also freely detachably mounted upon the front end of the main body or shaft 24 as shown and covers the electric light bulb mounted upon the front end.

The outer annular surface 28 of the outer transparent body 25 is provided with spirals or threads at a front end thereof designed to complementary mate with spirals or threads (not shown) provided upon an inner annular or concentric surface of a rear end of the cover 26, so that cover 26 and transparent body 25 can be screwed together in the direction of the dash-dot line in FIG. 7 to encompass the main body or shaft 24 as seen in FIG. 8. The rear end of the outer transparent body opposite the front end comprising the threads or spirals 28 is closed, similar to the embodiment shown in FIGS. 3 and 4.

In the embodiment illustrated in FIGS. 7 and 8, the electric light bulb mounted within the cover 26 is switched on or off by sliding a switch 27 slidably mounted upon the main body or stem 24 and protruding through an opening 26′ in the outer surface of the cover 26 as shown. However, alternative switching mechanism is also contemplated within the purview of the present invention. For example, the electric light in the embodiments shown in FIGS. 1-6 can be turned on or off by simply rotating the respective cover members mounted upon the main stem or shaft. Furthermore, switching mechanism can be provided in the form of a push button switch situated upon the main stem or shaft.

The inventive portable electric light allows not only for clear, protected display of images and/or information upon a main stem or shaft of the light, but also interchanging of information displayed upon an outer surface of the main stem or shaft, as needed. For example, safety information might be imprinted or affixed to the shaft in one language and need to be changed should the light components be shipped to a foreign country. If the light is shipped in assembled condition, then the various components can simply be uncoupled, e.g. unscrewed, with the information replaced on the main stem followed by re-assembly.

The portable electric light can be formed of any suitable natural or synthetic material, e.g., metal or hard plastic. The outer transparent member can be formed from transparent material such as glass, acrylics, polycarbonates, etc. all conventionally available.

The preceding description of the present invention is merely exemplary and not intended to limit the scope thereof in any way.

1. A portable electric light, comprising
a main body structured and arranged to allow a light bulb to be detachably mounted upon one end thereof and contain a battery or cell therein for supplying power to the light bulb;
a cover structured and arranged to be detachably secured to said main body to cover the light bulb mounted upon the end of said main body; and
an outer body at least partially formed of substantially transparent material and structured and arranged to concentrically encompass said main body such that images or patterns positioned upon an outer surface of said main body or between said main body and outer body are visible through said outer concentric body.

2. The light of claim 1, wherein said main body comprises a projection around the outer surface thereof and said outer body is structured and arranged to mate with said projection.

3. The light of claim 2, wherein said projection comprises a partially cut-away portion and said outer body comprises a convex portion structured and arranged to be inserted into said cut-away portion and then rotated to secure said outer body to said main body.

4. The light of claim 1, wherein said outer body is substantially cylindrical.

5. The light of claim 1, wherein said outer body has a multi-faceted or polygonal cross-section.

6. The light of claim 5, wherein said outer body possesses one of a triangular, rectangular or hexagonal cross-section.

7. The light of claim 1, additionally comprising a space defined between said main and outer bodies when assembled together for receiving and displaying an image such as letters or designs.

8. The light of claim 1, wherein the outer surface of said main body is formed to allow an image such as letters or designs to adhere thereto.

9. The light of claim 1, wherein said main and outer body are structured and arranged to allow the images or patterns to be changed.

10. The light of claim 1, wherein said cover and outer body are structured and arranged to be coupled together to retain said main body within said outer body.

11. The light of claim 10, wherein said cover and outer body comprise complementary spiral surfaces or threads which permit said cover and outer body to be screwed together.

12. The light of claim 11, wherein said threads are provided upon an inner concentric surface of said cover and outer concentric surface of said outer body.

13. The light of claim 11, additionally comprising a space defined between said main and outer body when assembled together for receiving and display the images or patterns.

14. The light of claim 1, wherein said cover is structured and arranged to turn the light bulb on or off by being rotated about said main body.

15. The light of claim 1, additionally comprising a switching mechanism slidably mounted upon said main body to turn the light bulb on or off by sliding in opposite directions.

16. The light of claim 1, wherein said cover member is structured and arranged to turn the light bulb on or off by being rotated about said main body.

17. The light of claim 11, additionally comprising a switching mechanism slidably mounted upon said main body to turn the light bulb on or off by sliding in opposite directions.

18. The light of claim 2, additionally comprising a cap structured and arranged to be coupled to said main body at an end opposite said cover to retain said outer body between said main body and cap.

19. The light of claim 2, wherein said projection comprises threads upon an outer surface thereof and said outer body comprises complementary threads upon an inner surface thereof such that said projection and outer body can be screwed together.
